(19) United States
(12) Patent Application Publication
(10) Pub. No.: US 2013/0228228 A1
(43) Pub. Date: Sep. 5, 2013

(54) METHOD AND DEVICE FOR JUDGING PROPRIETY OF EGR VALVE OPERATION

(71) Applicants: Kenji Akahane, Hino-shi (JP); Noriyuki Ishigami, Hino-shi (JP)

(72) Inventors: Kenji Akahane, Hino-shi (JP); Noriyuki Ishigami, Hino-shi (JP)

(73) Assignee: HINO MOTORS, LTD., Hino-shi (JP)

(21) Appl. No.: 13/885,110

(22) PCT Filed: Dec. 2, 2011
(86) PCT No.: PCT/JP11/06760

§ 371 Date: May 13, 2013

(30) Foreign Application Priority Data
Dec. 6, 2010 (JP) 2010-271229

(51) Int. Cl. F02M 25/07

(52) U.S. Cl. CPC F02M 25/0771
USPC 137/2; 137/59

(57) ABSTRACT

Provided are a temperature sensor 15 for detecting a temperature surrounding an EGR valve 12, judging means (IC chip 16) for judging on the basis of the detected temperature from the temperature sensor 15 whether an inside of a gas passage in the EGR valve 12 is frozen or not and a controller 17 for controlling an operation of the EGR valve 12. The controller 17 is adapted to forbid and allow an output of an operating command 17a to an actuator 14 for the EGR valve 12 when an inside of a gas passage in the EGR valve 12 is judged by the judging means (IC chip 16) to be frozen or unfrozen, respectively.

### TECHNICAL FIELD

The present invention relates to a method and a device for judging propriety of an EGR valve operation.

### BACKGROUND ART

For example, in an engine for an automobile, so-called exhaust gas recirculation (EGR) has been employed in which part of exhaust gas is extracted from an exhaust side and is returned to an intake-air side. The exhaust gas returned to the intake-air side suppresses combustion of fuel in the engine to lower a combustion temperature, thereby reducing NOₓ generation.

Generally, for execution of this kind of exhaust gas recirculation, an exhaust system from an exhaust manifold to an exhaust pipe is connected with an intake-air system from an intake pipe to an intake manifold through an EGR pipe constituting an EGR system, the exhaust gas being recirculated via the EGR pipe.

A water-cooled type EGR cooler may be incorporated in the EGR pipe which recirculates the exhaust gas to the engine since cooling of the exhaust gas to be recirculated to the engine during its passing through the EGR pipe will lower and reduce a temperature and a volume of the exhaust gas, which results in lowering of a combustion temperature without substantially lowering engine output and can effectively reduce nitrogen oxides generated.

There exists, for example, the following Patent Literature 1 as prior art document relating to this kind of EGR device.

### CITATION LIST

### Patent Literature

[Patent Literature 1] JP 2001-123889A

### SUMMARY OF INVENTION

### Technical Problems

However, in such an EGR device, an EGR valve may be frozen due to flocculated water generated in an EGR pipe for example in a particular condition where an engine is stopped after a long-term idling thereof in a cold climate or the like; then, in a next cold start, the frozen EGR valve may not be actuated in spite of operating command from the controller to the EGR valve for recirculation of the exhaust gas. When such malfunction of the EGR valve due to freezing is detected as abnormality, then unnecessary exchange of the EGR valve may be conducted owing to the detected abnormality irrespective of a fact that the EGR valve may be normally operated after thawing.

The invention was made in view of the above and has its object to prevent malfunction of an EGR valve due to freezing from being detected as abnormality and unnecessarily exchanged.

### Solution to Problems

The invention is directed to a method for judging propriety of an EGR valve operation characterized by detecting a temperature surrounding the EGR valve, judging on the basis of the detected temperature whether an inside of a gas passage in said EGR valve is frozen or not, and forbidding and allowing outputting of an operating command to an actuator for said EGR valve when the inside of the gas passage in said EGR valve is judged to be frozen and unfrozen, respectively.

In specifically executing the method for judging propriety of an EGR valve operation according to the invention, provided are a temperature sensor for detecting a temperature surrounding the EGR valve, judging means for judging on the basis of the detected temperature by said temperature sensor whether an inside of a gas passage in said EGR valve is frozen or not and a controller for controlling an operation of said EGR valve, said controller being adapted to forbid and allow an output of an operating command to an actuator for said EGR valve when the inside of the gas passage in said EGR valve is judged by said judging means to be frozen or unfrozen, respectively.

Thus, the temperature surrounding the EGR valve is detected by the temperature sensor, and whether the inside of the gas passage in the EGR valve is frozen or not is judged by the judging means on the basis of the detected temperature by the temperature sensor. When the inside of the gas passage is judged by the judging means to be frozen, an output of the operating command to the actuator for the EGR valve is forbidden to prevent the malfunction of the EGR valve due to the freezing from being detected as abnormality.

When the inside of the gas passage in the EGR valve is judged by the judging means to be unfrozen, then the output of the operating command to the actuator for the EGR valve is allowed to judge and detect as usual a malfunction of the EGR valve not due to freezing to be actual abnormality such as mechanical failure.

### Advantageous Effects of Invention

According to a method and a device for judging propriety of an EGR valve operation as mentioned in the above, a temperature surrounding an EGR valve is detected and, on the basis of the detected temperature, whether an inside of a gas passage in the EGR valve is frozen or not is judged; when the inside of the gas passage in the EGR valve is judged to be frozen, an output of an operating command to an actuator for the EGR valve can be forbidden, which brings about an excellent effect that malfunction of the EGR valve due to freezing can be prevented from being detected as abnormality to prevent unnecessary exchange of the EGR valve.

### BRIEF DESCRIPTION OF DRAWINGS

FIG. 1 is a schematic view showing an embodiment of the invention; and

FIG. 2 is a flowchart for illustration of judgment logic on propriety of EGR valve operation.

### DESCRIPTION OF EMBODIMENT

An embodiment of the invention will be disclosed in conjunction with the drawings.

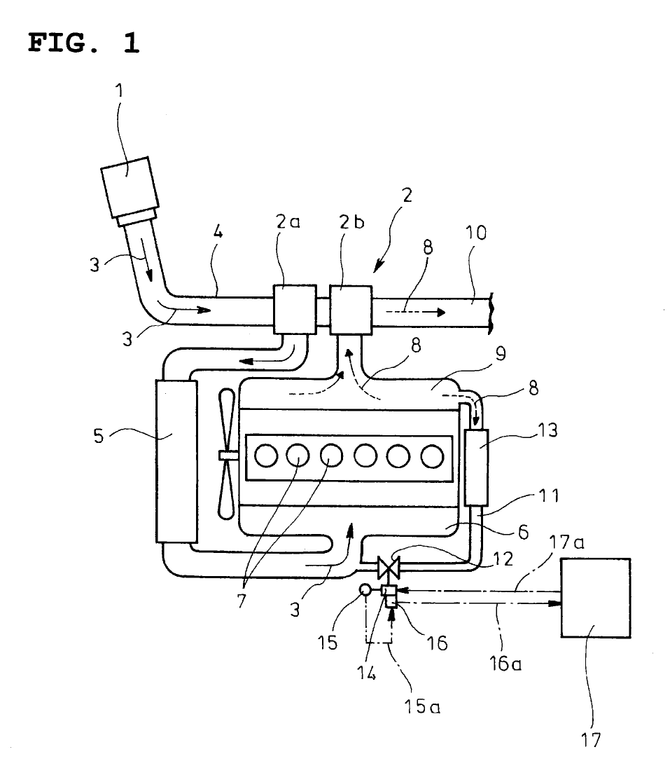

FIG. 1 shows the embodiment of the invention. In the illustrated embodiment, intake air 3 from an air cleaner 1 is sent through an intake pipe 4 to a compressor 2a of a turbocharger 2. The intake air 3 pressurized by the compressor 2a is sent to an intercooler 5 where the air is cooled and is further guided to an intake manifold 6 where the air is distributed to respective cylinders 7 of the engine (an in-line six-cylinder engine is illustrated in FIG. 1).

An exhaust gas 8 discharged from the respective cylinders 7 is sent through an exhaust manifold 9 to a turbine 2b of the turbocharger 2. The exhaust gas 8 having driven the turbine 2b is sent through an exhaust pipe 10 to outside of a vehicle.

An end of the exhaust manifold 9 in a direction of arrangement of the respective cylinders 7 is connected to a portion of the intake pipe 4 adjacent to an inlet of the intake manifold 6 through an EGR pipe 11 so as to extract part of the exhaust gas 8 from the exhaust manifold 9 into the intake pipe 4.

The EGR pipe 11 is provided with an openable and closable EGR valve 12 and an EGR cooler 13 for cooling of the exhaust gas 8 to be recirculated. In the EGR cooler 13, cooling water (not shown) is heat-exchanged with the exhaust gas 8 so as to lower a temperature in the exhaust gas 8.

Arranged in an actuator 14 for opening/closing operation of the EGR valve 12 are a temperature sensor 15 for detection of a temperature in the actuator 14 as temperature surrounding the EGR valve 12 as well as an IC chip 16 (judging means) for receiving a detection signal 15a from the temperature sensor 15 to judge on the basis of the detected temperature whether an inside of a gas passage in the EGR valve 12 is frozen or not. A judgment result from the IC chip 16 is inputted as a judgment signal 16a to a controller 17 controlling the EGR valve 12. (In FIG. 1, for convenience of illustration, the temperature sensor 15 and the IC chip 16 are drawn outside of the actuator 14.)

In the controller 17, an output of the operating command 17a is forbidden and allowed when the inside of the gas passage in the EGR valve 12 is judged by the IC chip 16 to be frozen and unfrozen, respectively.

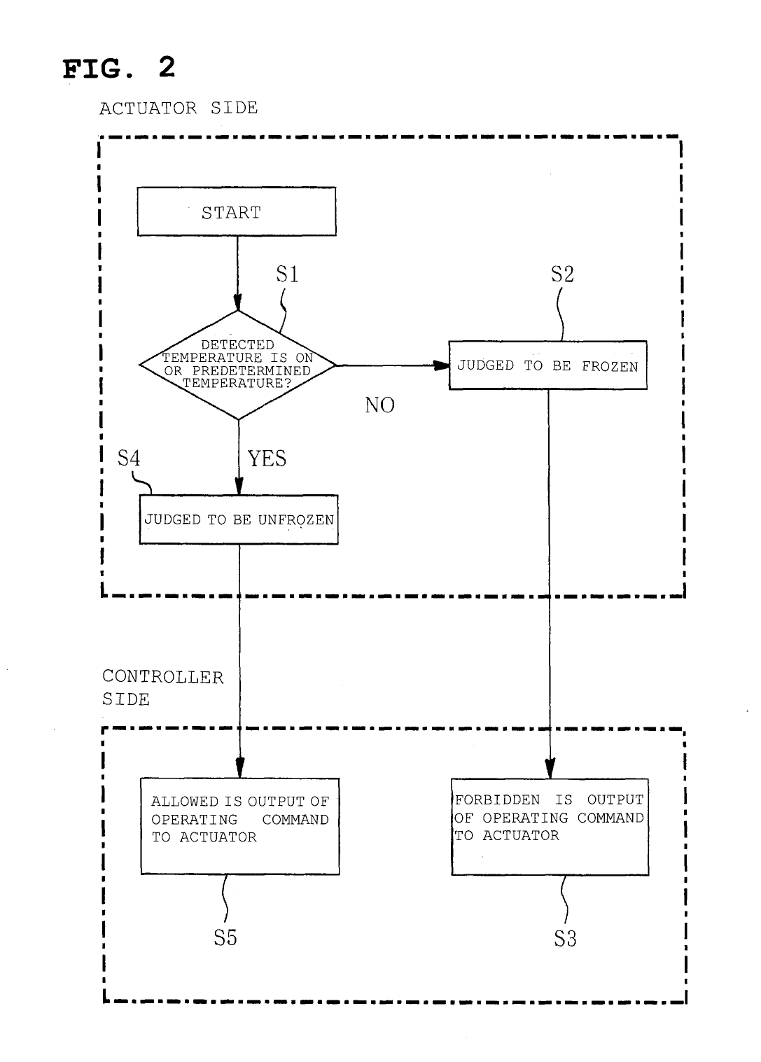

Specifically, judgment logic on propriety of the EGR valve 12 operation will be explain with respect to a flowchart of FIG. 2. Firstly in step S1 on the actuator 14 side, judged is whether the detected temperature by the temperature sensor 15 is on or above a predetermined temperature which is a threshold value for judgment on whether an inside of the gas passage in the EGR valve 12 is frozen or not. When the detected temperature is lower than the predetermined temperature, then the procedure proceeds to Step S2 where the inside of the gas passage in the EGR valve 12 is judged to be frozen. Then, in Step S3 on the controller 17 side, forbidden is an output of an operating command 17a to the actuator 14.

When the judgment in Step S1 on the actuator 14 side is to be on or above the predetermined temperature, the procedure proceeds to Step S4 where the inside of the gas passage in the EGR valve 12 is judged not to be frozen. Then, in Step S5 on the controller 17 side, allowed is the output of the operating command 17a to the actuator 14.

In the illustrated embodiment, the IC chip 16 incorporated in the actuator 14 for the EGR valve 12 is used as judging means for judging on being frozen or not. Of course, alternatively, a judgment program corresponding to the judging means may be incorporated on the controller 17 side to receive on the controller 17 side the detection signal 15a from the temperature sensor 15, so that the judgment program in the controller 17 is used as the judging means for judging, on the controller 17 side, on being frozen or not.

Thus, with the device for judging propriety of an EGR valve 12 operation constructed as mentioned in the above, the inner temperature of the actuator 14 is detected by the temperature sensor 15 as the temperature surrounding the EGR valve 12. On the basis of the detected temperature by the temperature sensor 15, whether the inside of the gas passage in the EGR valve 12 is frozen or not is judged by the IC chip 16. When the inside of the gas passage in the EGR valve 12 is judged by the IC chip 16 to be frozen, then the output of the operating command 17a to the actuator 14 for the EGR valve 12 is forbidden by the judgment signal 16a, so that the malfunction of the EGR valve 12 due to the freezing is prevented from being detected as abnormality.

When the inside of the gas passage in the EGR valve 12 is judged by the IC chip 16 not to be frozen, the output of the operating command 17a to the actuator 14 for the EGR valve 12 is allowed by the judgment signal 16a, so that the malfunction of the EGR valve 12 not due to the freezing is detected as usual as actual abnormality such as mechanical failure.

Thus, according to the above-mentioned embodiment, the temperature surrounding the EGR valve 12 is detected. On the basis of the detected temperature, judgment is made on whether the inside of the gas passage in the EGR valve 12 is frozen or not. When the inside of the gas passage in the EGR valve 12 is judged to be frozen, the output of the operating command 17a to the actuator 14 for the EGR valve 12 can be forbidden, so that the malfunction of the EGR valve 12 due to freezing can be prevented from being detected as abnormality to prevent unnecessary exchange of the EGR valve 12.

It is to be understood that a method and a device for judging propriety of an EGR valve operation are not limited to the above-mentioned embodiment. For example, illustrated in the above-mentioned embodiment is detection of the inner temperature of the actuator for the EGR valve by means of the temperature sensor arranged in the actuator; however, the temperature sensor may be arranged in any other position where the temperature surrounding the EGR valve can be detected.

### REFERENCE SIGNS LIST

12 EGR valve
14 actuator
15 temperature sensor
15a detection signal
16 IC chip (judging means)
16a judgment signal
17 controller
17a operating command

1. A method for judging propriety of an EGR valve operation which comprises detecting a temperature surrounding the EGR valve, judging on the basis of the detected temperature whether an inside of a gas passage in said EGR valve is frozen or not, and forbidding and allowing outputting of an operating command to an actuator for said EGR valve when the inside of the gas passage in said EGR valve is judged to be frozen and unfrozen, respectively.

2. A device for judging propriety of an EGR valve operation comprising a temperature sensor for detecting a temperature surrounding the EGR valve, judging means for judging on the basis of the detected temperature by said temperature sensor whether an inside of a gas passage in said EGR valve is frozen or not and a controller for controlling an operation of said EGR valve, said controller being adapted to forbid and allow an output of an operating command to an actuator for said EGR valve when the inside of the gas passage in said EGR valve is judged by said judging means to be frozen or unfrozen, respectively.
